(19) United States
(12) Patent Application Publication
(10) Pub. No.: US 2022/0366101 A1
(43) Pub. Date: Nov. 17, 2022

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Tomoyuki SUZUKI, Shinagawa Tokyo (JP)

(73) Assignee: KABUSHIKI KAISHA TOSHIBA, Tokyo (JP)

(21) Appl. No.: 17/686,344

(22) Filed: Mar. 3, 2022

(30) Foreign Application Priority Data
Apr. 22, 2021 (JP) 2021-072639

(51) Int. Cl. G06F 30/20

(52) U.S. Cl. CPC G06F 30/20; G06F 2111/10

(57) ABSTRACT

According to an embodiment, an information processing device of an embodiment includes a memory and one or more processors coupled to the memory. The memory stores therein time-series data including at least one of a dependent variable and an independent variable. The one or more processors are configured to: generate a nonlinear function based on at least one of the dependent variable and the independent variable; generate a linear regression equation in which the nonlinear function is a basis function; estimate a coefficient of the linear regression equation; calculate a product of the coefficient and a maximum value of the basis function corresponding to the coefficient, as a degree of influence; correct the coefficient based on the degree of influence; and output the linear regression equation expressed by the corrected coefficient.

### CROSS-REFERENCE TO RELATED APPLICATIONS

This application is based upon and claims the benefit of priority from Japanese Patent Application No. 2021-072639, filed on Apr. 22, 2021; the entire contents of which are incorporated herein by reference.

### FIELD

Embodiments described herein relate generally to an information processing device, an information processing method, and a computer program product.

### BACKGROUND

Conventionally, techniques for modelling a physical phenomenon have been known. For example, there are techniques for obtaining a mathematical model describing a physical phenomenon from time-series data by applying symbolic regression, which is a type of machine learning.

However, in the conventional techniques, it has been difficult to further improve the accuracy of generating a model of a physical phenomenon.

### BRIEF DESCRIPTION OF THE DRAWINGS

FIG. 1 is a diagram illustrating an example of a functional configuration of an information processing device according to an embodiment;

FIG. 2 is a flowchart illustrating an example of a generation method of a model according to the embodiment;

FIG. 3 is a diagram illustrating an example of results obtained when certain results of thermal fluid analysis are learned by a sequential threshold least square method;

FIG. 4 is a diagram illustrating an example of a power electronic apparatus that is an object subject to thermal fluid analysis;

FIG. 5 is a diagram illustrating an example of a component configuration of an electronic apparatus;

FIG. 6 is a diagram illustrating an example of temperature measurement points on a heat sink;

FIG. 7 is a diagram illustrating an example of the number and position of chips of the power electronic apparatus;

FIG. 8 is a diagram illustrating Example 1 of unknown input data to be input into a model generated by the information processing device according to the embodiment;

FIG. 9 is a diagram illustrating Example 1 of results (when Example 1 of input data is input) predicted by the model generated by the information processing device according to the embodiment;

FIG. 10A is a diagram illustrating Example 2 of unknown input data to be input into the model generated by the information processing device according to the embodiment;

FIG. 10B is a diagram illustrating Example 2 of unknown input data to be input into the model generated by the information processing device according to the embodiment;

FIG. 11 is a diagram illustrating Example 2 of results (when Example 2 of input data is input) predicted by the model generated by the information processing device according to the embodiment; and

FIG. 12 is a diagram illustrating an example of a hardware configuration of the information processing device according to the embodiment.

### DETAILED DESCRIPTION

According to an embodiment, an information processing device includes a memory and one or more processors coupled to the memory. The memory is configured to store therein time-series data including at least one of a dependent variable and an independent variable. The one or more processors are configured to: generate a nonlinear function based on at least one of the dependent variable and the independent variable; generate a linear regression equation in which the nonlinear function is a basis function; estimate a coefficient of the linear regression equation; calculate a product of the coefficient and a maximum value of the basis function corresponding to the coefficient, as a degree of influence; correct the coefficient based on the degree of influence; and output the linear regression equation expressed by the corrected coefficient.

Hereinafter, an embodiment of an information processing device, an information processing method, and a computer program product will be described in detail with reference to the accompanying drawings.

In a method described in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937 in which symbolic regression is developed, the following equation (1) is used, and it is assumed that the true model can be expressed by a linear combination of nonlinear terms.

\dot{X}=Θ(X)Ξ (1)

In the information processing device of the embodiment also, the above equation (1) is used, and it is assumed that the true model can be expressed using a linear combination of nonlinear terms. Then, the information processing device of the embodiment estimates a coefficient Ξ in the library in the following equation (2) that is composed of nonlinear function candidates, using a newly developed machine learning technique (new sparse estimation technique, which will be described below).

$$Θ ( X ) = [ \begin{matrix}\vert \\ 1 \\ \vert\end{matrix} \begin{matrix}\vert \\ X \\ \vert\end{matrix} \begin{matrix}\vert \\ {X}^{P 2} \\ \vert\end{matrix} \begin{matrix}\vert \\ ⋯ \\ \vert\end{matrix} \begin{matrix}\vert \\ sin ( X ) \\ \vert\end{matrix} \begin{matrix}\vert \\ ⋯ \\ \vert\end{matrix} ] \qquad ( 2 )$$

The information processing device of the embodiment can significantly reduce the time required for learning and the amount of data required for learning, by defining a search space in the library.

In the following embodiment, a thermal circuit network model is generated as a model of a physical phenomenon. In a node equation of a thermal circuit network method expressed by the following equation (3), time change in temperature can be expressed as a linear combination of nonlinear terms.

$${\sum }_{{j = 1}_{j ≏̸ i}}^{N} \frac{1}{{R}_{i j}^{( m )}} ( {T}_{i}^{( m )} - {T}_{j}^{( m )} ) = {Q}_{i}^{( m )} - \frac{{C}_{i}^{( m )}}{Δ t} ( {T}_{i}^{( m )} - {T}_{i}^{( m - 1 )} ) \to \frac{d {T}_{i}}{d t} = \frac{1}{{C}_{i}} \{ {Q}_{i} - {\sum }_{{j = 1}_{j \neq i}}^{N} \frac{1}{{R}_{i j}} ( {T}_{i} - {T}_{j} ) \} \qquad ( 3 )$$

There is a method of estimating a coefficient using a machine learning technique, by considering a library composed of candidates of a basis function proportional to the right-hand side. Most of coefficients in the given basis function are zero. Thus, the coefficient is estimated using a sparse estimation technique, which is a type of machine learning technique. A conventional sparse estimation technique operates properly when the variables are normalized. However, for example, the basis function candidates include addition and subtraction of variables to and from each other as in the right-hand side of the following equation (4), and the equation results have physical meanings. Hence, inconvenience occurs when the variables are normalized.

$$[ \begin{matrix}\vert & \vert & \vert & \vert & … \\ {\dot{T}}_{1} & {\dot{T}}_{2} & {\dot{T}}_{3} & {\dot{T}}_{4} & … \\ \vert & \vert & \vert & \vert & …\end{matrix} ] = [ \begin{matrix}\vert \\ {T}_{1} - {T}_{2} \\ \vert\end{matrix} \begin{matrix}\vert \\ {\vert \frac{{T}_{1} - {T}_{2}}{{T}_{1} + {T}_{2}} \vert}^{β} \\ \vert\end{matrix} \begin{matrix}\vert \\ ( {T}_{2} - {T}_{5} ) {v}^{a} \\ \vert\end{matrix} \begin{matrix}\vert \\ {T}_{2}^{ℽ} - {T}_{4}^{ℽ} \\ \vert\end{matrix} \begin{matrix}⋯ \\ ⋯ \\ ⋯\end{matrix} ] Ξ \qquad ( 4 )$$

For example, it is assumed that temperature T1 is within a range between 20 and 30 degrees Celsius, and temperature T2 is within a range between 20 and 50 degrees Celsius. The basis function includes a function proportional to temperature T2−temperature T1. In this example, if the temperature T1 is 20 degrees Celsius and the temperature T2 is 50 degrees Celsius, temperature T2−temperature T1 is 30 degrees Celsius when normalization is not performed. On the other hand, when normalization is performed within a range of 0 to 1, the temperature T2 becomes 1 and the temperature T1 becomes 0. Hence, temperature T2−temperature T1 becomes 1.

Moreover, for example, if the temperature T1 is 30 degrees Celsius and the temperature T2 is 35 degrees Celsius, temperature T2−temperature T1 is 5 degrees Celsius when normalization is not performed. On the other hand, when normalization is performed within a range of 0 to 1, the temperature T2 becomes 0.5, and the temperature T1 becomes 1. Hence, temperature T2−temperature T1 becomes −0.5. That is, while the temperature difference of 30 degrees Celsius is important in the former and the temperature difference of 5 degrees Celsius is important in the latter, when normalization is performed, the former becomes T1 and the latter becomes −0.5, and the physical meaning is lost.

Moreover, physical meaning is similarly lost when all nodes, that is, when temperatures T of N pieces are collectively normalized. For example, consider a case when the range of the temperature T1 is between 20 and 30 degrees Celsius, and the range of the temperature T2 is between 20 and 50 degrees Celsius, the temperatures T are collectively normalized. When the temperature T1 is changed from 20 degrees Celsius, 25 degrees Celsius, to 30 degrees Celsius, and when the temperature T2 is changed from 20 degrees Celsius, 50 degrees Celsius, to 40 degrees Celsius, the temperature T1 is normalized to 0, 0.17, and 0.33, and the temperature T2 is normalized to 0, 1, and 0.67.

In this example, when the subtraction of functions is subtraction of linear functions T2−T1, and when the temperatures T1 and T2 are changed as described above, T2−T1 becomes 0, 25, and 10 when normalization is not performed, and T2−T1 becomes 0, 0.83, and 0.33 when normalization is performed. In this process, it is 25/10 =2.5, 0.83/0.33 2.5. In this manner, when the linear functions are added or subtracted to and from each other, the relation of calculation results is satisfied even if the variables are normalized.

On the other hand, when the subtraction of functions is the subtraction of nonlinear functions T2²-T1², and when the temperatures T1 and T2 are changed as described above, T2²−T1² becomes 0, 109375, and 37000 when normalization is not performed, and T2²−T1² becomes 0, 1, and 0.26 when normalization is performed. In this process, it is 109375/37000 2.956, 1/0.26 3.846. In this manner, when the nonlinear functions are added or subtracted to and from each other, the relation of calculation results is lost when the variables are normalized.

When heat is taken into account, the absolute value of temperature is important. When the temperature at a location where temperature hardly changes (small temperature variation range) and the temperature at a location where temperature tends to change easily (large temperature variation range) are normalized to the same range (0 to 1), it is physically wrong.

However, in the conventional sparse estimation technique, a variable is selected on the basis of the magnitude of coefficient. Hence, the conventional sparse estimation technique does not operate properly when the ranges of basis functions are different from each other. For example, as a conventional sparse estimation technique, lasso in the following equation (5), and a sequential threshold least-squares algorithm (hereinafter, referred to as a “sequential threshold least square method”) developed in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937 are known.

min_{ξ}∥\dot{X}=Θ(X)Ξ∥₂²s.t.∥Ξ∥₁≤s (5)

When the ranges of the basis functions are different from each other, lasso in the above equation (5) does not operate properly. In addition, the sequential threshold least square method described in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937 also does not operate properly.

Moreover, the node equation used in the thermal circuit network method is a simultaneous differential equation expressed by the above equation (3). The left-hand side of the above equation (3) is a time differential of a dependent variable. Furthermore, the right-hand side of the above equation (3) is composed of terms the denominators of which are thermal capacity. The thermal capacity differs significantly depending on the node, and some nodes differ by five orders of magnitude or more. As a result, it is very difficult to appropriately set a threshold that makes each node to zero.

Consequently, in the information processing device of the embodiment, a new sparse estimation technique, which is applicable even if the dependent variable and the independent variable have an unnormalized value, is used. In the new sparse estimation technique, the sequential threshold least square method described in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937 is developed, and a basis function is selected from a point of view which of the terms in the right-hand side of the above equation (3) affects most on the left-hand side. That is, in the information processing device of the embodiment, the basis function is selected on the basis of the magnitude of the term (coefficient x basis function), instead of the coefficient in the right-hand side of the above equation (3).

Hereinafter, an operation example of the information processing device of the embodiment capable of further improving the accuracy of generating a model of a physical phenomenon will be described in detail.

### Example of Functional Configuration

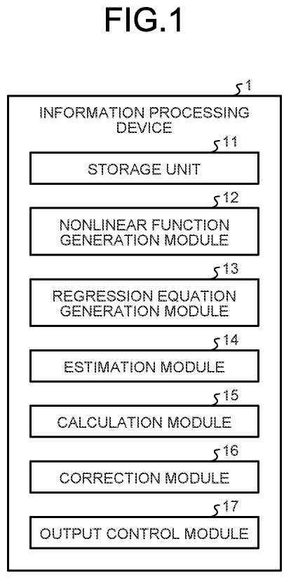

FIG. 1 is a diagram illustrating an example of a functional configuration of an information processing device 1 according to an embodiment. The information processing device 1 of the embodiment includes a storage unit 11, a nonlinear function generation module 12, a regression equation generation module 13, an estimation module 14, a calculation module 15, a correction module 16, and an output control module 17.

The storage unit 11 stores therein time-series data including at least one of a dependent variable and an independent variable. The dependent variable (response variable) is a variable determined depending on the independent variable (explanatory variable). The independent variable is a variable representing the factor of change in the dependent variable. For example, the dependent variable is temperature of an electronic component, a heat sink, and the like. For example, the independent variable is wind velocity indicating the strength of air from a fan for cooling an electronic component, electric current that flows through the electronic component, voltage supplied to the electronic component, and the like.

In the information processing device 1 of the embodiment, the value of the dependent variable is expressed by a unit unified for each physical quantity represented by the dependent variable. For example, if the physical quantity is weight, the value of the dependent variable is unified to kg or g, without mixing the dependent variable expressed in kg and the dependent variable expressed in g. Similarly, the value of the independent variable is expressed by a unit unified for each physical quantity represented by the independent variable.

The storage unit 11 may also store a plurality of types of time-series data. In the types of time-series data, at least one of the initial condition and boundary condition may be different.

The nonlinear function generation module 12 generates a nonlinear function on the basis of at least one of the dependent variable and the independent variable. For example, the nonlinear function generation module 12 generates a nonlinear function on the basis of temperature Tᵢ at a position i, and temperature Tⱼ at a position j.

The regression equation generation module 13 generates a linear regression equation in which the nonlinear function generated by the nonlinear function generation module 12 is used as a basis function.

The estimation module 14 estimates the coefficient of the linear regression equation generated by the regression equation generation module 13.

The calculation module 15 calculates a degree of influence on the basis of the magnitude of the term (coefficient×basis function). The value of the basis function (for example, Tᵢ−Tⱼ) changes over time. Thus, the maximum value in the time-series data is assumed as a representative value of the basis function. More specifically, the degree of influence is expressed by magnitude of term=coefficient ξₖⱼ×representative value of basis function maxᵢ|θᵢₖd|. That is, the calculation module 15 calculates a product of the coefficient estimated by the estimation module 14 and the maximum value of the basis function corresponding to the coefficient, as a degree of influence.

The correction module 16 corrects the coefficient on the basis of the degree of influence calculated by the calculation module 15. For example, the correction module 16 corrects the coefficient of the basis function in which the degree of influence is equal to or less than a threshold, to zero.

When a certain convergence condition is satisfied, the output control module 17 outputs a linear regression equation expressed by the corrected coefficient. For example, the certain convergence condition includes the number of repetition times of the machine learning process and the like.

### Example of Generation Method of Model

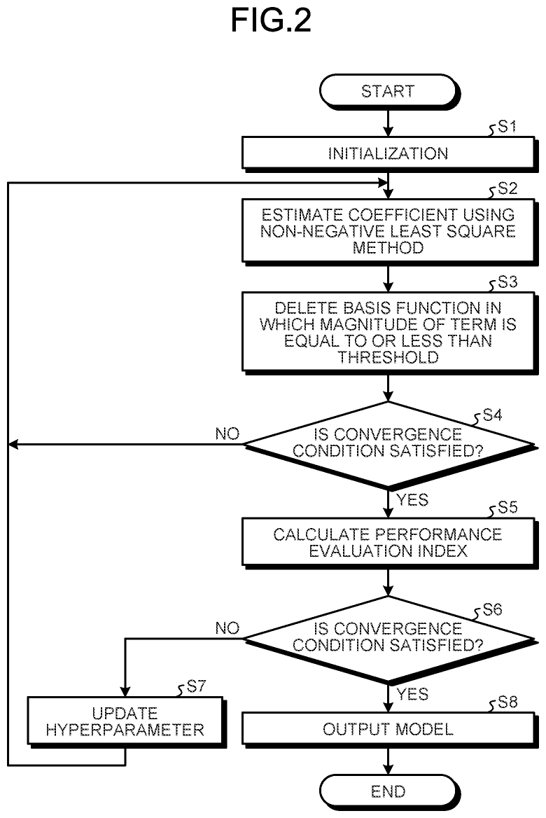

FIG. 2 is a flowchart illustrating an example of a generation method of a model according to the embodiment. First, the information processing device 1 initializes the data used when the model is machine learnt (for example, a hyperparameter and the like) (step S1).

Next, the estimation module 14 estimates the coefficient of the linear regression equation generated by the regression equation generation module 13 using a non-negative least square method in the following equation (6) (step S2).

min_{ξ}∥\dot{X}=Θ(X)Ξ∥₂²s.t.0≤ξₖⱼ (6)

The reason why the non-negative least square method is used at step S2 will now be described. In the conventional sequential threshold least square method, a coefficient is estimated using the least square method. However, when correlation of basis functions (≈variables) is very high, and when the number of learning data is small, the coefficient cannot be estimated properly, and the estimated value of the coefficient may become very high.

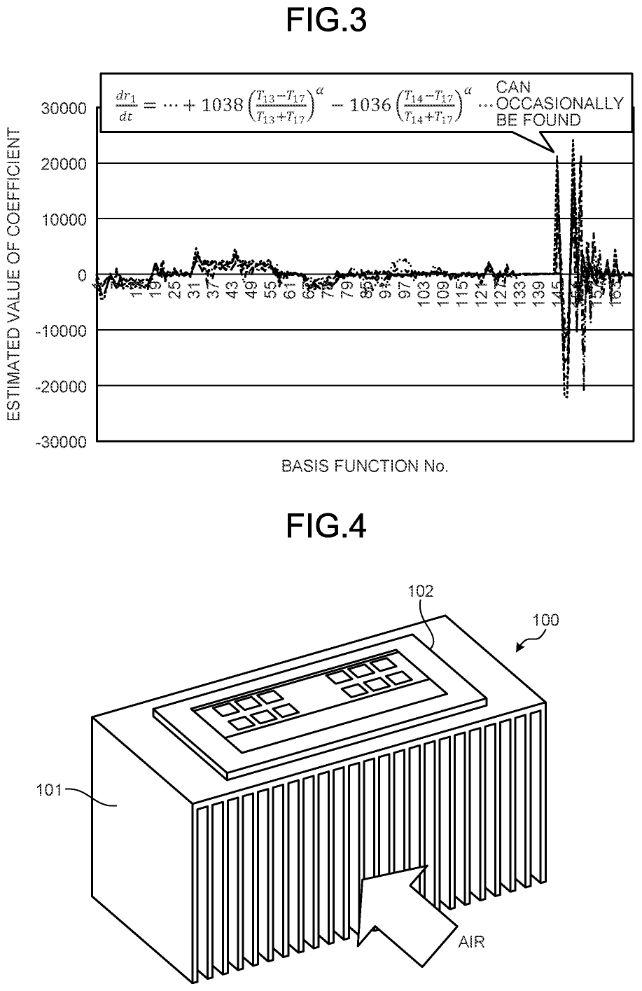

FIG. 3 is a diagram illustrating an example of results obtained when certain results of thermal fluid analysis are learned using the sequential threshold least square method. In the learning results in FIG. 3, a pair of basis functions with high correlation and a very large coefficient can be seen here and there. The total sum of these pairs is often a value close to zero with respect to the learning data. Such a coefficient of the basis function that seldom affects the left-hand side cannot be turned into zero at the following process step.

When a large number of basis functions with a large coefficient remain, the equation becomes unstable. Thus, by using the fact that a sign of a coefficient is uniquely determined when a way of acquiring the basis function in the right-hand side of the above equation (3) is improved, the estimation module 14 of the embodiment estimates the coefficient using the non-negative least square method. Then, the basis functions with high correlation do not mutually cancel out the effects.

Returning to FIG. 2, next, when the calculation module 15 calculates the degree of influence (magnitude of term) described above, and when the correction module 16 corrects the coefficient of the basis function in which the degree of influence is equal to or less than a threshold, to zero, the basis function in which the degree of influence is equal to or less than a threshold is deleted (step S3). For example, the threshold is represented by the right-hand side of the following equation (7).

ξₖⱼ maxᵢ∥θᵢₖ∥≤tol×Σₖ(ξₖⱼ maxᵢ∥θᵢₖ∥) (7)

In this example, tol is a hyperparameter, and it is tol<1. i represents time, and j represents space (node). k is an identification number of the basis function. As illustrated in the right-hand side of the above equation (7), the threshold is varied by j (by taking the influence of time constant into consideration).

The correction module 16 corrects the coefficient of a basis function θₖ corresponding to the term (ξₖⱼ maxᵢ∥θᵢₖ∥), which is equal to or less than tol times of the total sum of the magnitude of terms, to zero.

The threshold may also be the right-hand side of the following equation (8). That is, the correction module 16 may also correct the coefficient of the basis function θₖ corresponding to the term (ξₖⱼ maxᵢ∥θᵢₖ∥), which is equal to or less than tol times of the term that has affected the left-hand side most, to zero.

ξₖⱼ maxᵢ∥θᵢₖ∥≤tol×maxₖ(ξₖⱼ maxᵢ∥θᵢₖ∥) (8)

Next, the correction module 16 determines whether the results of the estimation and correction processes of the coefficient have satisfied the convergence condition (step S4).

For example, the convergence condition is the number of times the estimation and correction processes of the coefficient are executed. In this case, after the linear regression equation is updated by the coefficient corrected by the correction module 16, the estimation module 14 estimates the coefficient of the updated liner regression equation again. Next, the calculation module 15 updates the degree of influence by a product of the coefficient of the updated linear regression equation and the maximum value of the basis function corresponding to the coefficient of the updated linear regression equation. Then, on the basis of the updated degree of influence, the correction module 16 corrects the coefficient of the updated linear regression equation again. The information processing device 1 repeats the estimation of coefficient described above, the calculation of degree of influence described above, and the correction of coefficient described above for a predetermined number of times.

When the convergence condition is not satisfied (No at step S4), the process returns to step S2. When the convergence condition is satisfied (Yes at step S4), the output control module 17 calculates a performance evaluation index of the model (step S5). Next, the output control module 17 determines whether the learned model has satisfied the convergence condition (step S6). For example, the convergence condition is the number of times the learning processes of the model are executed. Moreover, for example, the convergence condition is when the performance evaluation index calculated by the process at step S5 is greater than a predetermined evaluation threshold. When the convergence condition is not satisfied (No at step S6), the hyperparameter is updated (step S7), and the process returns to step S2.

When the convergence condition is satisfied (Yes at step S6), the output control module 17 outputs the model (step S8).

### Explanation of Effects

Next, accuracy of the model generated by the information processing device 1 of the embodiment will be described.

FIG. 4 is a diagram illustrating an example of a power electronic apparatus 100 that is an object subject to thermal fluid analysis. The power electronic apparatus 100 includes a heat sink 101 and an electronic apparatus 102. The heat sink 101 cools the electronic apparatus 102. Air is blown to the heat sink 101 from a fan. The electronic apparatus 102 controls the operation of the power electronic apparatus 100. For example, the power electronic apparatus 100 is a power module.

For example, the information processing device 1 of the embodiment generates a model that expresses a thermal fluid analysis with several million nodes with 60 nodes, for example, by performing the machine learning described above, using the time-series data including the temperature history of 60 nodes of the thermal fluid analysis to be performed on the power electronic apparatus 100.

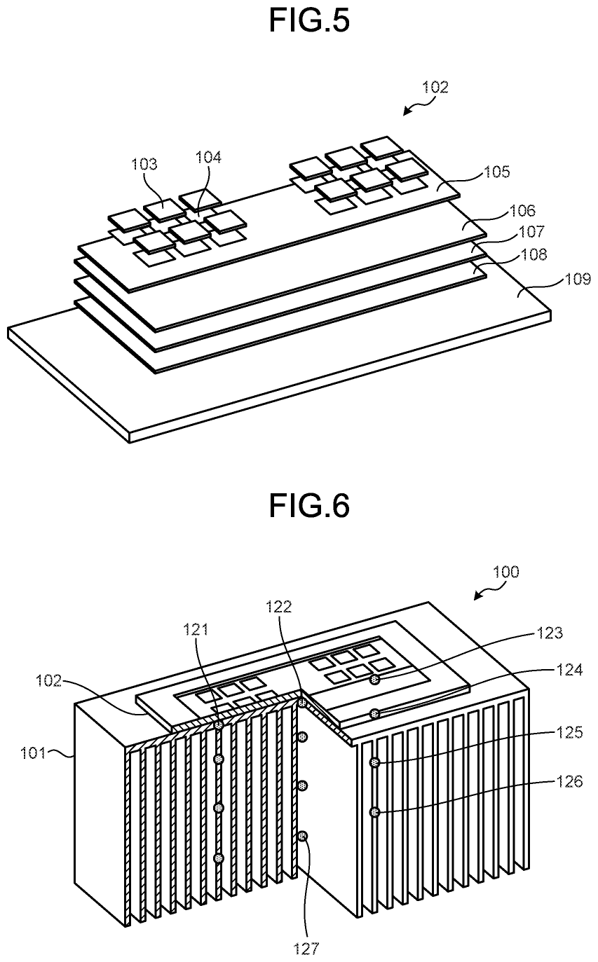

FIG. 5 is a diagram illustrating an example of a component configuration of the electronic apparatus 102. The electronic apparatus 102 includes a chip 103, a bonding member 104, a component 105, a component 106, a component 107, a boding member 108, and a component 109.

FIG. 6 is a diagram illustrating an example of temperature measurement points (nodes) on the heat sink 101. The temperature history of the heat sink 101 is measured at a plurality of nodes including nodes 121 to 127 and the like.

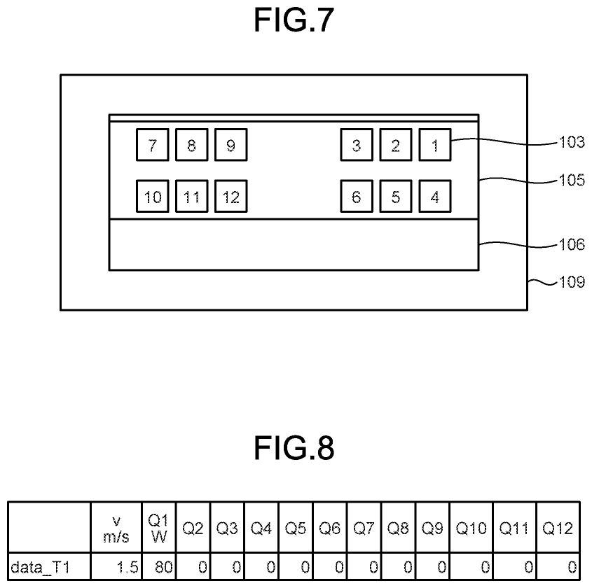

FIG. 7 is a diagram illustrating an example of the number and position of the chip 103 of the power electronic apparatus 100. For example, in the power electronic apparatus 100, the first to twelfth chips 103 are mounted and arranged as illustrated in FIG. 7. The chips 103 at the first to twelfth positions are each indicated as a chip_1 to a chip_12.

In verification of the effectiveness of the model generated by the information processing device 1 of the embodiment to be described below, the input data includes 73 variables (heat generation amount of the chip_1 to chip_12, wind velocity of a fan that blows air to the heat sink, and initial temperature at 60 locations (nodes)), and the output data includes 60 variables (temperature at 60 locations). Moreover, the learning data is results of thermal fluid analysis performed twelve times. The range of learning data includes the heat generation amount of 1 to 69 W, and the wind velocity 1.0 to 2.0 m/s of the fan. The range of evaluation data (unknown input data not included in the learning data) includes the heat generation amount of 0 to 80 W, and the wind velocity 1.5 to 3.5 m/s of the fan.

FIG. 8 is a diagram illustrating Example 1 of unknown input data to be input into the model generated by the information processing device 1 according to the embodiment. v represents the speed of wind (wind velocity) blown to the heat sink 101. Q1 to Q12 represent the heat generation amount of the chip_1 to chip_12.

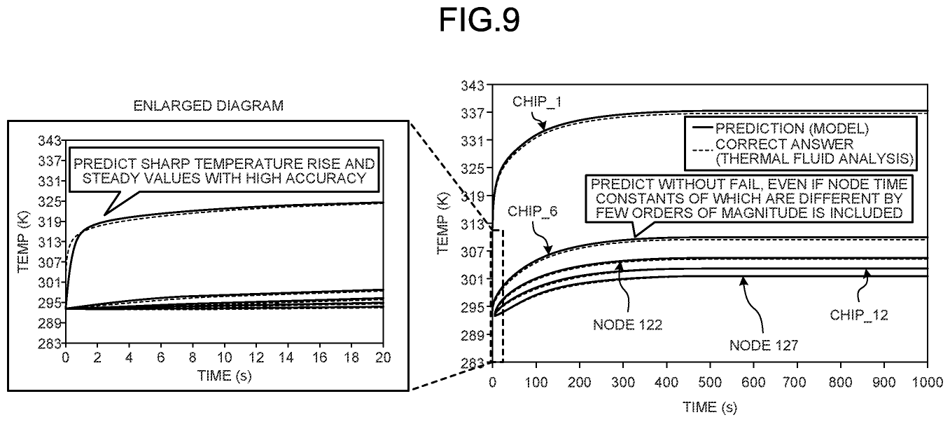

FIG. 9 is a diagram illustrating Example 1 of results (when Example 1 of input data is input) predicted by the model generated by the information processing device 1 according to the embodiment. In the example of FIG. 9, prediction results of temperature change at the node included in each of the chip_1, chip_6, and chip_12, and at the nodes 122 and 127 of the heat sink 101 are illustrated. The dotted line indicates the result predicted by the model. The solid line indicates the result (correct answer) of thermal fluid analysis. As illustrated in the prediction result of the temperature change at the chip_1, the model generated by the information processing device 1 of the embodiment can predict the sharp temperature rise immediately after the start of measurement and the steady values afterward with high accuracy. Moreover, the model is predicting the temperature change without fail, even if a node is included in an object to be measured in which the time constants are different by a few orders of magnitude.

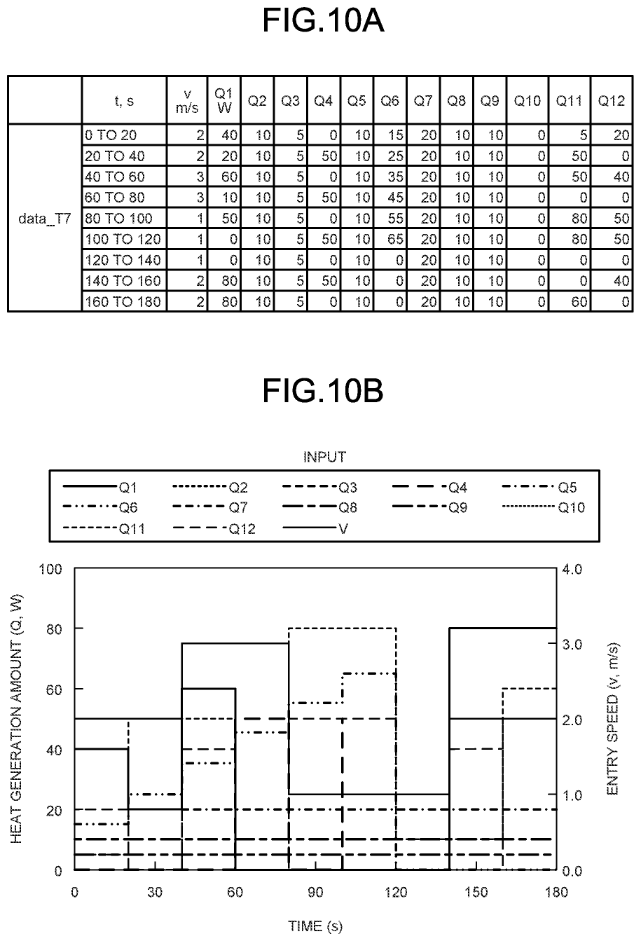

FIG. 10A and FIG. 10B are each a diagram illustrating Example 2 of input data of the model generated by the information processing device 1 according to the embodiment. In Example 2 of the input data, the heat generation amount is not constant, and is varied as in FIG. 10B.

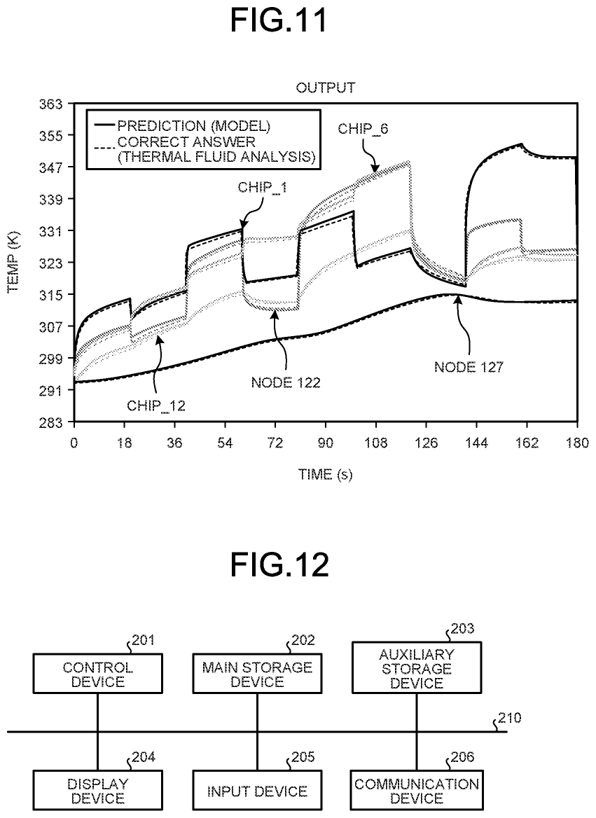

FIG. 11 is a diagram illustrating Example 2 of results (when Example 2 of input data is input) predicted by the model generated by the information processing device 1 according to the embodiment. As illustrated in FIG. 11, even if the heat generation amount is varied, the model generated by the information processing device 1 of the embodiment can predict the temperature change at the node included in each of the chip_1, the chip_6, and the chip_12, and the nodes 122 and 127 of the heat sink 101 with high accuracy.

As described above, in the information processing device 1 of the embodiment, the storage unit 11 stores therein the time-series data that includes at least one of the dependent variable and the independent variable. The nonlinear function generation module 12 generates a nonlinear function on the basis of at least one of the dependent variable and the independent variable. The regression equation generation module 13 generates a linear regression equation in which the nonlinear function is a basis function. The estimation module 14 estimates the coefficient of the linear regression equation. The calculation module 15 calculates a product of the coefficient and the maximum value of the basis function corresponding to the coefficient, as a degree of influence. The correction module 16 corrects the coefficient on the basis of the degree of influence. Then, the output control module 17 outputs the linear regression equation expressed by the corrected coefficient.

In this manner, with the information processing device 1 of the embodiment, it is possible to further improve the accuracy of generating a model of a physical phenomenon.

While the above-described embodiment describes a case where the information processing device 1 generates the linear regression equation of the thermal model, the linear regression equation of a model of another physical phenomenon (for example, electric resistance or physical deformation amount) may be generated.

Finally, an example of a hardware configuration of the information processing device 1 of the embodiment will be described.

### Example of Hardware Configuration

FIG. 12 is a diagram illustrating an example of a hardware configuration of the information processing device 1 according to the embodiment.

The information processing device 1 of the embodiment includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The control device 201 executes a computer program read out to the main storage device 202 from the auxiliary storage device 203. The main storage device 202 is memory such as read only memory (ROM) and random access memory (RAM). The auxiliary storage device 203 is a hard disk drive (HDD), a memory card, and the like.

The display device 204 displays display information. For example, the display device 204 is a liquid crystal display and the like. The input device 205 is an interface for operating the information processing device 1. For example, the input device 205 is a keyboard, a mouse, and the like. When the information processing device 1 is a smartphone or a smart device such as a tablet-type terminal, for example, the display device 204 and the input device 205 are a touch panel.

The communication device 206 is an interface for communicating with another device and the like.

A computer program executed by the information processing device 1 of the embodiment is recorded on a computer-readable storage medium such as a compact disc-read only memory (CD-ROM), a memory card, a compact disc-recordable (CD-R), and a digital versatile disc (DVD) in an installable or executable file format, and is provided as a computer program product.

Moreover, the computer program executed by the information processing device 1 of the embodiment may also be stored on a computer connected to a network such as Internet, and may be provided by causing a user to download the computer program via the network. Furthermore, the computer program executed by the information processing device 1 of the embodiment may also be provided via a network such as Internet without causing a user to download the computer program.

Still furthermore, the computer program of the information processing device 1 of the embodiment may also be provided by being incorporated in advance in ROM or the like.

The computer program executed by the information processing device 1 of the embodiment has a modular configuration including functional blocks that can also be implemented by a computer program among the functional blocks described above (FIG. 1). The functional blocks, as actual hardware, are loaded onto the main storage device 202, when the control device 201 reads the computer program from the storage medium, and executes the computer program. That is, the functional blocks are generated on the main storage device 202.

A part or the whole of the functional blocks described above may be implemented by hardware such as an integrated circuit (IC) instead of being implemented by software.

Moreover, when the functions are implemented using a plurality of processors, each processor may implement one of the functions or implement two or more functions.

Furthermore, an operating mode of the information processing device 1 of the embodiment may be optional. For example, the information processing device 1 of the embodiment may be operated as a cloud system on a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a memory configured to store therein time-series data including at least one of a dependent variable and an independent variable;
one or more processors coupled to the memory and configured to:
generate a nonlinear function based on at least one of the dependent variable and the independent variable;
generate a linear regression equation in which the nonlinear function is a basis function;
estimate a coefficient of the linear regression equation;
calculate a product of the coefficient and a maximum value of the basis function corresponding to the coefficient, as a degree of influence;
correct the coefficient based on the degree of influence; and
output the linear regression equation expressed by the corrected coefficient.

2. The device according to claim 1, wherein
the one or more processors are configured to:
update the linear regression equation by the corrected coefficient and then estimate the coefficient of the updated linear regression equation again;
update the degree of influence by a product of the coefficient of the updated linear regression equation and a maximum value of the basis function corresponding to the coefficient of the updated linear regression equation; and
again correct the coefficient of the updated linear regression equation based on the updated degree of influence, and
the estimation of the coefficient, the calculation of the degree of influence, and the correction of the coefficient are repeated for a predetermined number of times.

3. The device according to claim 1, wherein the dependent variable and the independent variable have an unnormalized value.

4. The device according to claim 1, wherein the one or more processors are configured to correct a coefficient of the basis function, in which the degree of influence is equal to or less than a threshold, to zero.

5. The device according to claim 1, wherein the one or more processors are configured to estimate the coefficient by using a non-negative least square method.

6. The device according to claim 1, wherein
the memory is configured to store therein a plurality of types of the time-series data, and
the types of time-series data are time-series data in which at least one of an initial condition and a boundary condition differs.

7. The device according to claim 1, wherein a left-hand side of the linear regression equation includes a time differential of the dependent variable.

8. The device according to claim 1, wherein
a value of the dependent variable is expressed by a unit unified for each physical quantity represented by the dependent variable, and
a value of the independent variable is expressed by a unit unified for each physical quantity represented by the independent variable.

9. An information processing method, comprising:
storing time-series data including at least one of a dependent variable and an independent variable;
generating a nonlinear function based on at least one of the dependent variable and the independent variable;
generating a linear regression equation in which the nonlinear function is a basis function;
estimating a coefficient of the linear regression equation;
calculating a product of the coefficient and a maximum value of the basis function corresponding to the coefficient, as a degree of influence;
correcting the coefficient based on the degree of influence; and
outputting the linear regression equation expressed by the corrected coefficient.

10. A computer program product comprising a non-transitory computer-readable medium including programmed instructions, the instructions causing a computer to execute:
storing time-series data including at least one of a dependent variable and an independent variable;
generating a nonlinear function based on at least one of the dependent variable and the independent variable;
generating a linear regression equation in which the nonlinear function is a basis function;
estimating a coefficient of the linear regression equation;
calculating a product of the coefficient and a maximum value of the basis function corresponding to the coefficient, as a degree of influence;
correcting the coefficient based on the degree of influence; and
outputting the linear regression equation expressed by the corrected coefficient.
